(19) United States
(12) Patent Application Publication
(10) Pub. No.: US 2008/0107494 A1
(43) Pub. Date: May 8, 2008

(54) Power tool with fuel cell and hydraulic power supply

(76) Inventor: Chih-Ching Hsieh, Taichung City (TW)

Correspondence Address: PHILLIP LIU, 6980, WHITEOAK DR., RICHMOND, BC, V7EAZ9, omitted

(21) Appl. No.: 11/593,195

(22) Filed: Nov. 3, 2006

(51) Int. Cl. B23B 45/02

(52) U.S. Cl. 408/241 R

(57) ABSTRACT

A power tool includes a barrel with an output portion rotatably extending from a front end of the barrel, and a handle with a switch is connected to the barrel. An electric unit and a hydraulic unit are received in the barrel so that the output portion is driven by either the electric unit or the hydraulic unit. A water collecting device is located close to the output portion and collects water during operation and the water is decomposed into oxygen and hydrogen. The oxygen and hydrogen are provided to a fuel cell which is connected between the electric unit and the water collecting device. The fuel cell uses the oxygen and hydrogen to generate power.

### FIELD OF THE INVENTION

The present invention relates to a power tool with a fuel cell and a hydraulic power supply such as an air compressor so as to selectively drive the output portion fo the power tool.

### BACKGROUND OF THE INVENTION

A conventional power tool such as a drill generally includes a handle and a barrel which includes an output portion and the output is driven by a power supply so as to screw a screw into an object. The power supply includes a hydraulic power supply such as an air compressor which provides high pressure air to drive the output portion. However, the air compressor occupies a certain space and requires a hose to be connected between the handle of the power tool and the compressor. The hose limits the range that the power tool moves and the hose might tangle objects during operation. The other power supply is a battery pack which is connected to the handle of the power tool and provides a lower voltage of power to drive the output portion. Although the battery pack does not need a hose, it cannot provide sufficient power as the compressor does so that the battery pack can only be used to small power tools.

The present invention intends to provide a power tool with both of the hydraulic power supply and the fuel cell so that the users can selectively use either of the hydraulic power supply or the fuel cell.

### SUMMARY OF THE INVENTION

The present invention relates to a power tool that comprises a barrel with an output portion rotatably extending from a front end of the barrel, and an electric unit and a hydraulic unit are received in the barrel. The electric unit and the hydraulic unit are respectively connected to the output portion. A handle is connected to the barrel and has a switch so as to activate the electric unit and the hydraulic unit. A water collecting device is connected to the barrel and a fuel cell is connected between the electric unit and the water collecting device.

The primary object of the present invention is to provide a power tool that includes an electric unit and a hydraulic unit, and the user can choose either one of the electric unit and the hydraulic unit to drive the output portion of the power tool.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a user holds the handle of the power tool of the present invention to drive a screw into an object;

FIG. 2 is a perspective view to show the power tool of the present invention;

FIG. 3 is a side view to show the power tool of the present invention, and

FIG. 4 shows the connection between the parts of the power tool of the present invention.

### DETAILED DESCRIPTION OF THE PREFERRED EMBODIMENT

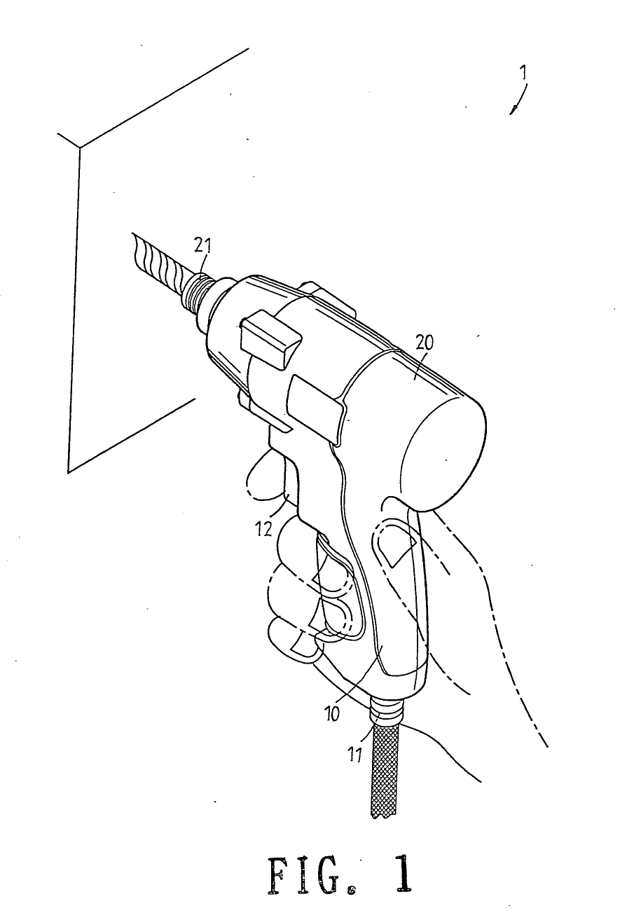

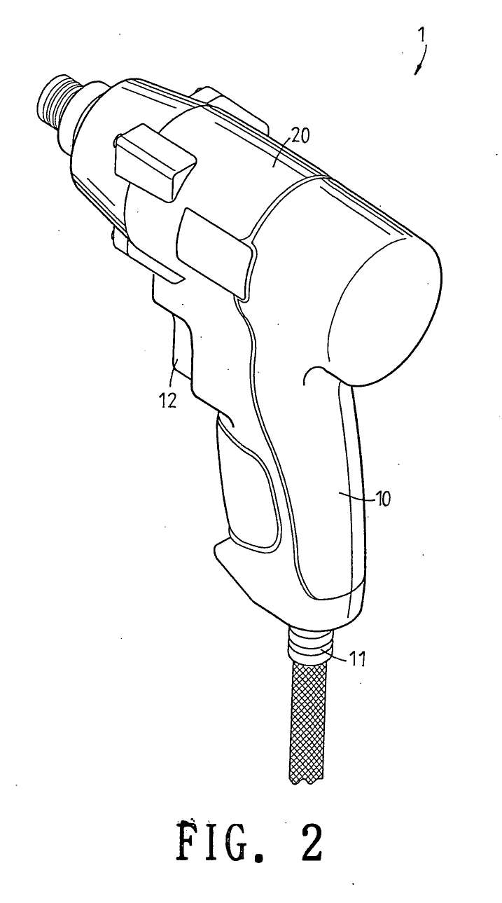

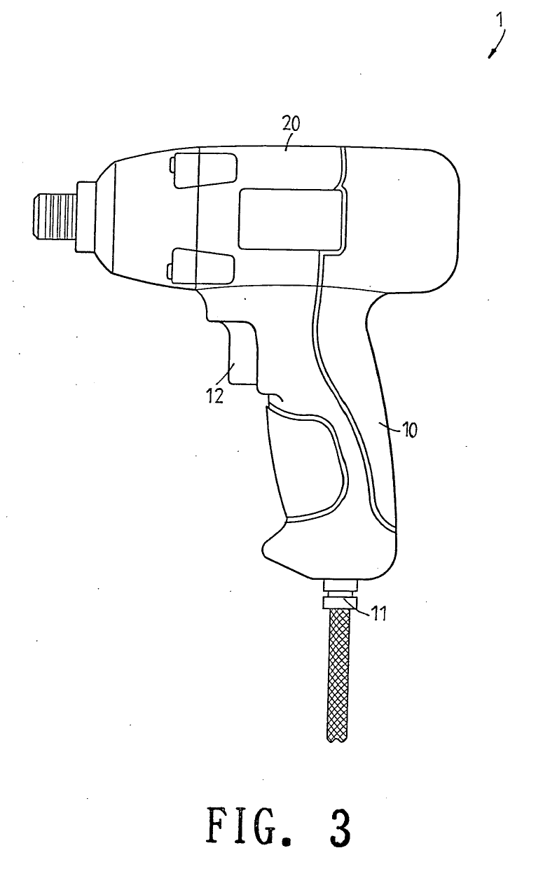

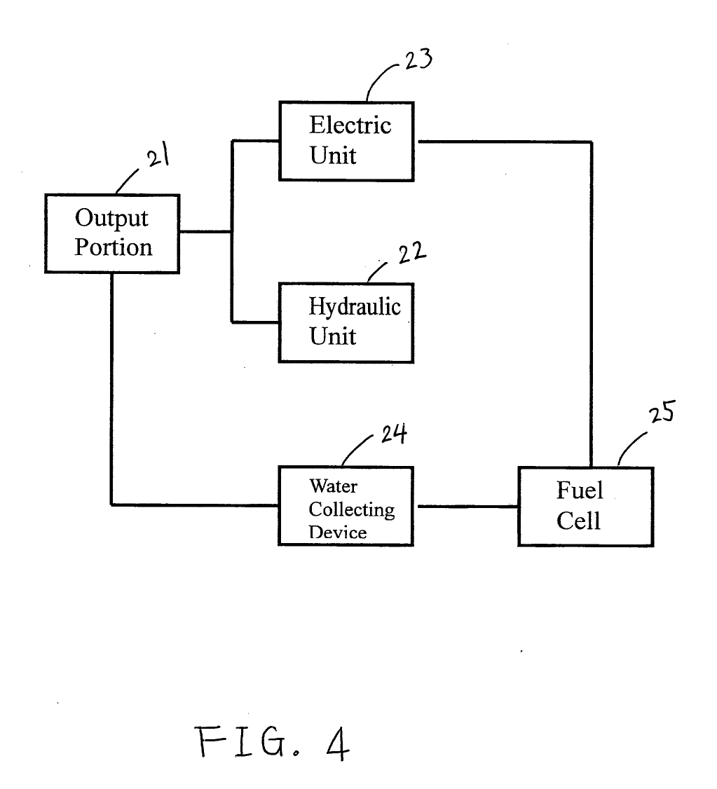

Referring to FIGS. 1 to 4, the power tool 1 of the present invention comprises a barrel 20 with an output portion 21 rotatably extending from a front end of the barrel 20. A handle 10 is connected to the barrel 20 and has a switch 12 connected thereto. A connection member 11 is connected to a distal end of the handle 10 so as to be connected to a hose which is connected with an air compressor (not shown).

An electric unit 23 and a hydraulic unit 22 are received in the barrel 20, and the electric unit 23 and the hydraulic unit 22 are respectively connected to the output portion 21. A water collecting device 24 is connected to the barrel 20 and located close to the output portion 21. A fuel cell 25 is connected between the electric unit 23 and the water collecting device 24. The water collection device 24 includes a catalytic member so as to decompose water into oxygen and hydrogen.

When the user connects the power tool 1 with an air compressor, the output portion 21 is driven by pressurized air provided by the air compressor as shown in FIG. 1. When the user wants to use the fuel cell 23 to drive the output portion 21, the hose is removed, and electric power is provided by the fuel cell 23. During operation, the bit or drill connected to the output portion 21 generates high temperature because of friction and when the air of high temperature encounters cool air, condensed water is generated and collected by the water collection device 24 which is located close to the output portion 21. The water is then decomposed into oxygen and hydrogen so as to be bounded again to generate electric power by the fuel cell 23.

The power tool 1 of the present invention is equipped with both of the electric unit 23 and the hydraulic unit 22 so that the users can choose either one of the two power supplies conveniently.

While we have shown and described the embodiment in accordance with the present invention, it should be clear to those skilled in the art that further embodiments may be made without departing from the scope of the present invention.

What is claimed is:

1. A power tool comprising:
a barrel with an output portion rotatably extending from a front end of the barrel, an electric unit and a hydraulic unit received in the barrel, the electric unit and the hydraulic unit respectively connected to the output portion;
a handle connected to the barrel and having a switch connected thereto, and
a water collecting device connected to the barrel and a fuel cell connected between the electric unit and the water collecting device.

2. The power tool as claimed in claim 1, wherein a connection member is connected to a distal end of the handle so as to be adapted to connect a hose.

3. The power tool as claimed in claim 1, wherein the water collection device includes a catalytic member.
